(19) United States
(12) Patent Application Publication
(10) Pub. No.: US 2020/0257760 A1
(43) Pub. Date: Aug. 13, 2020

(54) METHOD OF CREATING AND OPTIMIZING CUSTOMIZED DATA SHEETS, CUSTOMER PORTAL AND NON-TRANSITORY COMPUTER-READABLE RECORDING MEDIUM

(71) Applicant: Rohde & Schwarz GmbH & Co. KG, Munchen (DE)

(72) Inventors: Matthias RUNGELER, Markt Schwaben (DE); Tortsen SCHORR, Munchen (DE)

(21) Appl. No.: 16/274,938

(22) Filed: Feb. 13, 2019

(51) Int. Cl. G06F 17/24

(52) U.S. Cl. CPC G06F 17/248; G06F 17/243

(57) ABSTRACT

A method of creating customized data sheets for a predefined instrument type comprising: determining performance metrics for a plurality of different instrument types. Each set of performance metrics for a specific instrument type is based on different scenarios. The performance metrics, together with the instrument type and performance scenarios are stored in a database. A human-machine interface is coupled to the database and configured to assist the user in performing a user request using a guided interaction process. A user request may comprise a first request for a selected instrument or type and a second request for a selected subset of performance scenarios for the selected instrument. The human-machine interface may automatically generate a customized data sheet based on the user request by extracting from the database the information of the selected instrument type and the subset of performance scenarios together with the corresponding performance metrics.

### FIELD OF THE INVENTION

The present invention relates to a method of creating and optimizing customized data sheets. The invention further relates to a customer portal and a non-transitory computer-readable recording medium.

### TECHNICAL BACKGROUND

A data sheet, datasheet, or spec sheet is a document that summarizes the performance and other technical characteristics of an electronic device (or component thereof, subsystem, machine, software, etc.) in sufficient detail that allows a design engineer to understand the role of the component in the overall system. In the data sheet, for each device type, the electric characteristics to be published are represented by numerical values or corresponding graphs. Furthermore, in regard to the electric characteristics, a value of a characteristic parameter and a graph of a characteristic curve are described for each of various items.

Presently, for data sheet generation an engineer takes some measuring instruments and measures data sheet values for a limited number of performance scenarios. This has to be repeated for every new hardware and software version of the electronic device. For each new electronic device type, a new device-specific data sheet is then created. For example, for a spectrum analyzer the amplitude flatness in dB for a certain signal power, attenuation in the instrument, bandwidth and frequency are stated. Each parameter depends on many different variables, however, only a few of them are specified in the data sheet. Additionally, in practice, these parameters are measured using only few measuring devices and as such may not be representative. Also, the user may be interested in data sheet values for different performance scenarios. As such, the generated data sheet is a non-individualized across-the-board data sheet that does typically not contain specific values and/or performance scenarios which are relevant for the specific user of this specific electronic device.

US 2016/0320432 A1 discloses the generation of a data sheet for a device under test (DUT). A user, who is not familiar with how to properly use the measurement instrument for measuring a DUT, is assisted to select the performance parameters for the data sheet and then perform the measurements automatically. It also aggregates each measurement in a database. However, the generation of the data sheets is based on the measurements, but does not generate a brief data sheet for the user of the measurement instrument based on the specifics of the user's planned measurement.

### SUMMARY OF THE INVENTION

Against this background, there is the need to provide a customized data sheet generation. Accordingly, the present invention provides according to aspects of the present invention a method of creating customized data sheets, a customer portal for creating customized data sheets and a non-transitory computer-readable recording medium having the features of the independent claims.

According to a first aspect of the invention, a method of creating and optimizing customized data sheets is provided for a predefined instrument type, the method comprising: determining, using a measurement equipment and controlled by a controller, an amount of performance metrics for a plurality of different instrument types, wherein each set of performance metrics for a specific instrument type is based on a plurality of different performance scenarios; storing the performance metrics together with corresponding information of the instrument type and performance scenarios in a database; providing a human-machine interface coupled to the database, wherein the human-machine interface is configured to credibly assist the user in performing a user request by employing of a guided human-machine interaction process; receiving the user request via an input terminal of the human-machine interface, wherein the user request comprises a first request for a selected instrument or instrument type of the plurality of instrument types and a second request for a selected subset of performance scenarios of the plurality of different performance scenarios for the selected instrument or instrument type; generating, by the human-machine interface, a customized data sheet automatically based on the user request by extracting from the database the information of the selected instrument type and the selected subset of performance scenarios together with the corresponding performance metrics.

According to a second aspect of the invention, a customer portal for creating and optimizing customized data sheets is provided for a predefined instrument type, the customer portal comprising: a database which is configured to store performance metrics of an instrument type together with corresponding information of the instrument type and performance scenarios; providing a human-machine interface coupled to the database, wherein the human-machine interface comprises an input terminal for receiving user requests and wherein the human-machine interface is configured to credibly assist a user in performing a user request by employing of a guided human-machine interaction process by receiving from a user a first request for a selected instrument or instrument type of the plurality of instrument types and a second request for a selected subset of performance scenarios of the plurality of different performance scenarios for the selected instrument or instrument type, and to generate automatically a customized data sheet based on the user request by extracting from the database the information of the selected instrument type and the selected subset of performance scenarios together with the corresponding performance metrics.

According to a third aspect of the invention, a non-transitory computer-readable recording medium is provided, the customer portal. The non-transitory computer-readable recording medium is configured to store instructions executable by a computer processor and to cause the computer processor to execute a method of creating and optimizing customized data sheets for a predefined instrument type, comprising: determining an amount of performance metrics for a plurality of different instrument types, wherein each set of performance metrics for a specific instrument type is based on a plurality of different performance scenarios; storing the performance metrics together with corresponding information of the instrument type and performance scenarios in a database; receiving the user request via an input terminal of a human-machine interface, which human-machine interface is configured to credibly assist the user in performing a user request by employing of a guided human-machine interaction process, wherein the user request comprises a first request for a selected instrument or instrument type of the plurality of instrument types and a second request for a selected subset of performance scenarios of the plurality of different performance scenarios for the selected instrument or instrument type; generating a customized data sheet automatically based on the user request by extracting from the database the information of the selected instrument type and the selected subset of performance scenarios together with the corresponding performance metrics.

The present invention is based on the knowledge that an exciting current flowing through the excitation device is influenced not only by the periodic signal, but also by the current flowing through the power supply line.

The present invention is based on the idea to automatically measure all imaginable scenarios for a plurality of instruments, instrument types or components thereof and to suitably store this information in a database. Upon request of a user, a customized data sheet may then be generated. This customized data sheet comprises only those customized information, such as performance metrics and performance scenarios that are requested and/or needed by the user. As the data sheet generated in this way no longer contains information that is not relevant for the user, a higher quality is achieved with this data sheet generation technique which in addition is less expensive than known non-customized techniques.

Also, the quality of the performance metrics, for example different values, in the data sheet may be increased for example from “nominal” (i.e. desired by the designer) to “typical” (i.e. actually measured). Further, depending on the number of data base entries, statistical information such as mean, standard deviation, minimum and maximum can be generated.

Advantageous configurations and developments emerge from the further dependent claims and from the description with reference to the figures of the drawings. According to a particularly preferred aspect, the method further comprises the steps of operating the selected instrument based on the selected subset of performance scenarios in order to obtain information of the performance metrics under customized operation conditions, and feeding back the obtained information of the performance metrics under customized operation conditions to the measurement equipment and to the controller for an update determination of the amount of performance metrics for the plurality of different instrument types. The particular benefit is that the manufacturer of the corresponding instruments receives information on how the customer preferably or typically uses the corresponding instruments under operation conditions, i.e. when, how and which performance scenarios and settings are preferred and less preferred. In addition, the manufacturer receives information on which settings the customer uses during operation, for example at which frequency operating point measurements are preferred. The feedback of this information provides the manufacturer with a qualitative assessment of the application profile of the instruments used by the customer. On the basis of this information, the manufacturer can then direct his development resources so that future instruments are better adapted to the respective customer wishes, requirements and application profiles. The manufacturer's knowledge of what the various customers of the instruments want means that the corresponding instruments can be adapted accordingly. This leads to an increase in the quality of the corresponding equipment and equipment with improved and/or additional functions can be provided.

The selected instrument is connected to the measurement equipment and the controller via a communication link. The communication link is preferably an internet connection, however, may also be any other wired or wireless connection. In one preferred aspect, the obtained information is then forwarded via the communication link immediately and dynamically. However, it may also be sufficient that the information is forwarded after predefined intervals, such as after every measurement.

Typically, a service or maintenance of the selected instrument is conducted regularly, preferably by the manufacturer and more preferably at the site of the manufacturer. Typical service intervals are one to two years. The service is very recommendable for complex instruments, such oscilloscopes, spectrum analyzers, network analyzers, measurement instruments and the like. A specific and important task during service is in particular the calibration of the instrument and/or their parts. In one alternative or additional aspect, the obtained information is read out during the conducted service or maintenance and is then forwarded to the measurement equipment, the controller and/or the database.

According to a particularly preferred aspect, the method comprises the step of post-processing the performance metrics and storing the post-processed performance metrics together with corresponding information of the instrument type and performance scenarios in the database. The post-processing may be performed based on a predefined template and by employing a controller. In a particular preferred embodiment, the post-processed performance metrics are obtained by interpolating previously measured measurement results. Depending on the specific purpose, a data sheet may also offer different types of values, such as average values, typical values, typical ranges of the value, maximum values, minimum values, engineering tolerances, and/or nominal values. These different types of values may also be obtained via the post-processing step.

According to a further preferred aspect, the extracted information which is used for the generation of the customized data sheet is additionally displayed to a user on a display. This way, the user obtains the feedback of which information will actually be illustrated in the generated data sheet.

In a preferred development, the displaying of the information on the display is performed before the step of generating a customized data sheet by the human-machine interface is executed. This has the advantage that the user obtains these information before the data sheet is finalized so that he has the option to make amendments or adaptions, such as deleting some of the information or adding additional information.

The measurement scenario include at least one of the following parameters: input power, measurement bandwidth, carrier frequency of an input signal, signal type, operating temperature, setting of the compensations for particular standards and/or internal settings. Other measurement scenarios and/or parameters may also be applicable. Optionally, the data sheet further contains the particular performance of the instrument as well as worst-case device performance for each performance metric.

In a further preferred configuration, the generating step further comprises the step of providing a template comprising first fields for the selected subset of performance scenarios, second fields for the corresponding performance metrics and third fields for information of the selected instrument type and wherein the customized data sheet is generated by inserting the information in the corresponding fields. It goes without saying that alternative or additional fields may also exist.

In another preferred aspect, the step of determining an amount of performance metrics comprises the step of providing the performance metrics by the instrument itself. This may be done e.g. every time when the user sets up a particular measurement.

In one development, the method further comprises the step of logging the user request from the human-machine-interface, and adding additional performance scenarios to the requested performance scenarios.

In a further preferred aspect, the method comprises the step of predicting the estimated performance of a device on performance scenarios which are not tested by modeling the actual performance of measurement scenarios which are tested. This is a pretty smart technique which is in particular advantageous for those application where a huge amount of different instrument types are present which however show a similar technical characteristics and behavior. In particular, by modeling parameters additional performance scenarios can be provided to the user (e.g. 1 dB more uncertainty to amplitude flatness for each Ghz RF).

In a further aspect, the generated data sheet is an electronic data sheet. An electronic data sheet specifies characteristics in a formal structure that allows the information to be processed by a computer or machine. Such machine readable descriptions can facilitate information retrieval, display, design, testing, interfacing, verification, and system discovery.

According to a preferred development, the human-machine-interface comprises a web service and the guided human-machine interaction process is a web-based service. This is in particular advantageous since then the data sheet may be generated upon demand by a user from anywhere, e.g. in a factory facility, so that an on-site data sheet generation is possible.

In a further preferred aspect, the method comprises the step of using artificial intelligence techniques, such as trained or trainable neural networks and/or machine learning techniques, for inferring performance metrics. This lowers the overall measuring effort, reduces the database requirements and in addition provides very reliable results.

In one aspect, the method comprises the step of storing a compact representation of the performance metrics for all measurement scenarios on the tested instrument itself.

According to a typical and preferred configuration, the method is applicable for automatic data sheet generation for at least one of the following instrument types: measurement instrument; test equipment; spectrum analyzer; network analyzer; signal generator; oscilloscope. It goes without saying that the method may also be effectively applied for other electric and electronic devices, components, systems and the like.

Where appropriate, the above-mentioned configurations and developments can be combined in any manner. Further possible configurations, developments and implementations of the invention also include combinations, which are not explicitly mentioned, of features of the invention which have been described previously or are described in the following with reference to the embodiments. In particular, in this case, a person skilled in the art will also add individual aspects as improvements or supplements to the basic form of the present invention.

### BRIEF DESCRIPTION OF THE DRAWINGS

The present invention is described in greater detail in the following on the basis of the embodiments shown in the schematic figures of the drawings, in which:

FIG. 1 is a flow chart illustrating a method of creating and optimizing customized data sheets according to one aspect of the present invention;

FIG. 2 is a flow chart illustrating a method of creating and optimizing customized data sheets according to a further aspect of the present invention;

FIG. 3 is a block diagram illustrating a customer portal for creating and optimizing customized data sheets according to one aspect of the present invention.

The appended drawings are intended to provide further understanding of the embodiments of the invention. They illustrate embodiments and, in conjunction with the description, help to explain principles and concepts of the invention. Other embodiments and many of the advantages mentioned become apparent in view of the drawings. The elements in the drawings are not necessarily shown to scale.

### DETAILED DESCRIPTION

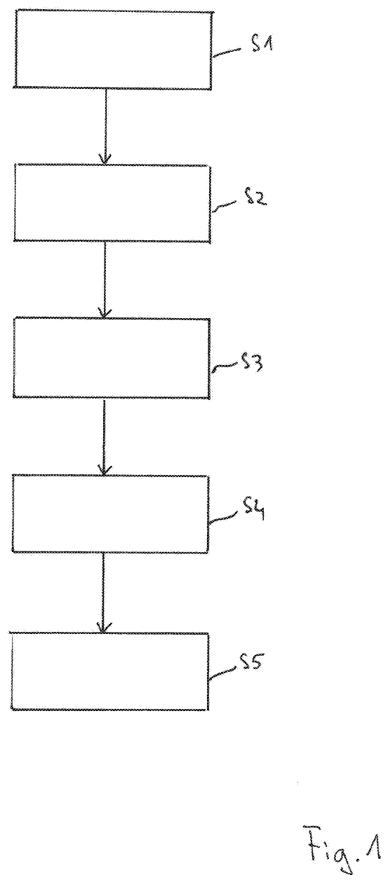

FIG. 1 shows a flow chart illustrating a method of creating customized data sheets according to one aspect of the present invention.

In a first step S1, an amount of performance metrics for a plurality of different instrument types is determined. The performance metrics, e.g. the measuring values, are provided by the manufacturer of the instrument and/or are measured using a suitable measuring equipment. Since depending on the specific purpose, a data sheet may offer different types of values, such as average values, typical values, typical ranges of the value, engineering tolerances, and/or nominal values, this additional information are preferably obtained by employing a suitable post-processing step (not shown in FIG. 1). Further, each set of performance metrics for a specific instrument type is based on a plurality of different performance scenarios. The determination of the performance metrics is typically controlled by a controller, which may be part of the measuring equipment and/or the tested instrument itself.

In a subsequent step S2, the determined performance metrics are stored in a database along with corresponding information of the tested instrument type and applied performance scenarios.

In a next step S3, a human-machine interface coupled to the database is provided. According to an essential function of the human-machine interface, the human-machine interface is configured to suitably assist the user in performing a user request, e.g. by applying a request-response communication. This is done according to the invention by employing a guided human-machine interaction process.

In a next step S4, a user starts the guided human-machine interaction process with the human-machine interface by employing an input terminal of the human-machine interface. The user inputs a request which is received by the human-machine interface. The user request comprises a first request for a selected instrument or instrument type of the plurality of instrument types. After the first user request is received, the human-machine interface offers to the user a choice, e.g. suitable set of performance scenarios for this instrument or this instrument type. The user then selects via a second request a subset of performance scenarios of the plurality of different performance scenarios for the selected instrument or instrument type. It goes without saying that it is also possible to reverse the sequence of the first and second request.

In a final step S5, the human-machine interface generates a customized data sheet automatically based on the user request, i.e. based on information obtained via the first and second user request. This is done by extracting, from the database, the information of the selected instrument type and the selected subset of performance scenarios and by merging them together with the corresponding performance metrics.

It goes without saying that for the sort of presentation of the data sheet there exist a plurality of different options, such as the presentation of the information on a paper data sheet, on a display (such as on a smart phone or the measuring equipment), in form of an electronic data sheet, etc. Also, the data values may be inserted in predefined fields of a suitable template and/or in the form of a graphical representation.

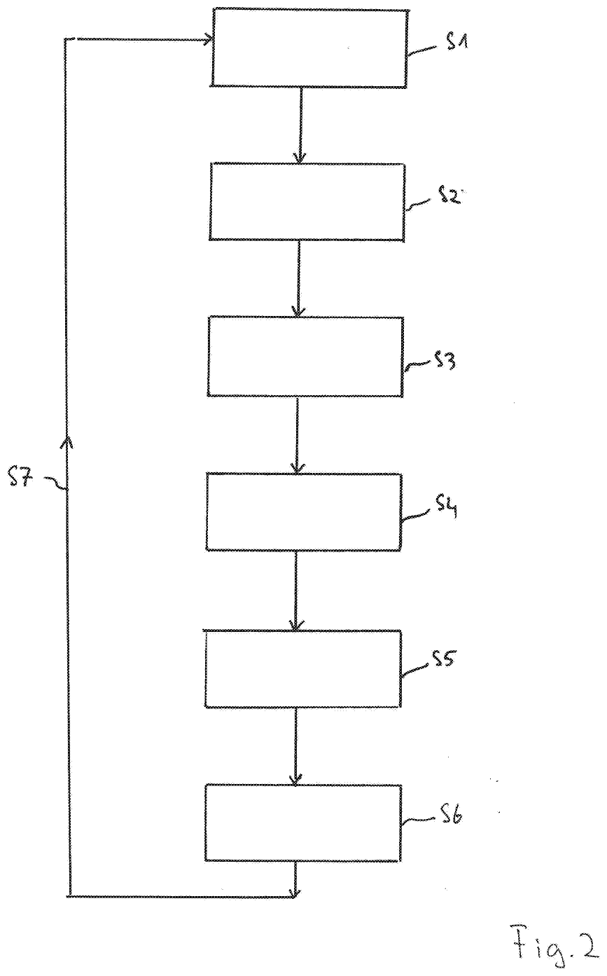

FIG. 2 shows a flow chart illustrating a method of creating and optimizing customized data sheets according to a further aspect of the present invention. The method shown in FIG. 2 comprises basically the steps S1-S5 of the method shown in FIG. 1. Additionally, the method in FIG. 2 comprises the further steps S6 and S7 which constitute a feed-back-loop.

In step S6, which is following to step S5, the selected instrument is operated based on the selected subset of performance scenarios. During operation mode, information of the performance metrics under customized operation conditions are obtained.

In a subsequent step S7, which forms a feedback-loop, the obtained information of the performance metrics are then feedback to the measurement equipment and to the controller in step S1 or the database in step S2 (not shown in FIG. 2). This way, it is possible to provide an update determination of the amount of performance metrics for the plurality of different instrument types.

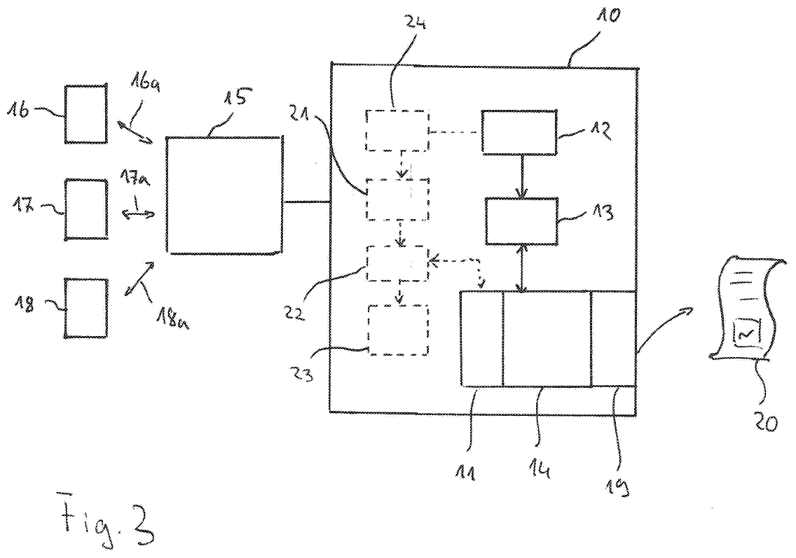

FIG. 3 shows a block diagram illustrating a customer portal for creating and optimizing customized data sheets according to one aspect of the present invention. The customer portal is denoted by reference numeral 10. The customer portal 10 comprises a database 12, a controller 13 and a human-machine interface 14. Further, the customer portal 10 is connectable to a measuring equipment 15.

The measuring equipment 15 may be a rack or set of measurement instruments. The measuring equipment 15 may further comprise all equipment and devices which are needed for testing and/or measuring purposes, such as a power meter, signal generator, computer for IQ export, markers, etc. (not shown in FIG. 3). An external or internal computer controls the rack of measurement instruments and runs several measurement scenarios.

The measuring equipment 15 is configured to perform the testing of different instruments and/or instrument types, such as network analyzer, spectrum analyzer, oscilloscope, or any other electric or electronic devices. In FIG. 3, the different instrument types tested by the measuring equipment 15 are denoted by different reference numeral 16, 17, 18 and the testing of these instruments 16, 17, 18 is indicated by the arrows 16a, 17a, 18a.

The measuring equipment 15 is configured to perform at least one of the following measurements:
amplitude flatness (+-dB), deviation from linear phase)(+-° and/or level uncertainty (+-dB) (all for certain bandwidths (80 MHz, 320 MHz, 500 MHz, 2 GHz) and RFs (0-8 GHz, <26.5 GHz, <85 GHz));
displayed average noise level;
phase noise, e.g. in decibel relative to the carrier (dBc) at lkhz Offset or 10 kHz Offset;
Electromagnetic compatibility (EMC) such as defined in IEEE802.11 ac @5 GHz;
intermodulation, such as third order intermodulation or second order intermodulation;
residual spurious response.

The measuring equipment 15 is configured to determine for each of the instruments 16, 17, 18 (or instrument types) a specific amount of performance metrics. Each set of performance metrics for a specific instrument type is based on one or a plurality of performance scenarios which are specific for the corresponding instrument type.

For measurement purposes, the measuring equipment 15 may employ a specific software which for example performs the measurement based on a parameter of the above list. This software may be part of a separate, specifically designed measurement computer, which is part of the measuring equipment 15, but not of the measurement instrument device 16, 17, 18. This software may be configured to derive performance values (such as amplitude flatness, noise floor, etc.) from raw measurement data (such as IQ-samples, quantizer data, etc.).

The performance metrics X determined by the measuring equipment 15 are then stored in the database 12 of the customer portal 10. Typically, but not necessarily, corresponding information of the tested instrument type and performance scenarios are stored in the database 12 either.

Preferably, but not necessarily, the information gathered during the measurement are post-processed using a controller 13, e.g. for providing average, minimum and/or maximum values, extrapolating and/or interpolating previously measured values, etc.

The human-machine interface 14 which is coupled to the database 12 comprises an input terminal 11. The input terminal 11 is configured to receive user requests. The human-machine-interface 14 is configured to assist a user (such as a customer) in performing a user request which is received via the input terminal 11. In particular, the human-machine-interface 14 is configured to assist a user by means of a guided human-machine interaction process. If the human-machine-interface 14 receives from a user a first request for a selected instrument or instrument type of the plurality of available instrument types, then it offers to the user a choice, depending on the user-selected instrument or instrument type, for a selected subset of performance scenarios (i.e. operating modes) of the plurality of different performance scenarios. This choice of the selected subset of performance scenarios which are also fetched from the database are assigned to the specific instrument or instrument type. In particular, by example, the user can state certain measurement settings of the measurement equipment 15. These measurement settings may include amplitude flatness for 10 dB attenuation and 200 MHZ bandwidth for FSW-67 @50 GHz.

After the user has made his choice, i.e. has selected the user-defined performance scenarios, an output module 19 within the customer portal 10 and connected to the human-machine-interface 14 is generating automatically a customized data sheet 20. This customized data sheet generation is made by extracting from the database 12 the information of the selected instrument type and the selected subset of performance scenarios together with the corresponding performance metrics.

The human-machine interface 14 may comprise e.g. one or more drop down menus selecting the different performance scenarios, a drill down selection, etc. The user has the option to select among e.g. various input powers, various measurement bandwidths, carrier frequency of input, signal type (OFDM wide band or narrowband sinusoidal), different operating temperature, setting of the compensations for particular standards (e.g. amount of acceptable phase noise compensation for the measurement instrument), internal settings, such as IF attenuation or amplifiers in the processing chains.

The extraction of the information from the database 12 may be gathered by estimating, interpolating and/or predicting data or information which may be obtained by a suitable database. The estimating, interpolating and/or predicting of information from a database may be done by storing values for a center frequency of 50 GHz and 52 GHz and subsequently by executing a preferably linear interpolation of the values for 51 Ghz. The database may preferably be a lookup database, but can also be any kind of storage means or a cloud based memory.

A specific software may be employed for the task of information gathering and/or for creating a statistics if several measurements are available. A suitable software may also be employed for creating a nicely formatted document with required values.

According to a specific preferred aspect, these information, such as direct measurement values, estimated/interpolated or predicted values, statistical information, etc., are communicated directly to the user. The user may also query additional information, such as requesting the spectrum flatness for a predefined device. This user request may then—in the form of a feedback loop—communicated to an application engineer responsible for this task and/or included directly to the list of measurements to be conducted, such as the ones sketched above.

In an additional or alternative aspect of this invention, all datasheet information and values which are necessary for the datasheet are stored (additionally or alternatively) in auditable database 12 of the tested measurement instrument 15. As such, a compact representation of the measurements of all imaginable scenarios is already stored on the measurement instrument 15. This has the additional benefit, that for example the measurement instrument 15 directly shows the expected measurement uncertainty, if the user has selected a certain measurement scenario.

For this additional or alternative aspect, which in FIG. 3 is illustrated in dotted lines, the technical implementation may comprise at least one of the following:

The measurement instrument 15 comprises a database 24. The database 24 comprises a compact representation of some or all measurement results. The database 24 can be part of the database 12 or can also be a separate storage means.

The measurement instrument 15 further comprises a smart interface 21. The smart interface 21 is configured to know the state of all relevant configurations of the measurement instrument 15, such as of the hardware switches, settings, parameters, etc.

The measurement instrument 15 further comprises a software module 22. The software module 22 is configured to derive from measurement information from ongoing measurement which the user currently conducts, such as which uncertainty parameters are relevant for the user and which are not. The software module 22 is further configured to estimate, interpolate and/or predict the uncertainty of the measurement based on hardware settings, information from the database, customer measurement scenario, etc.

The measurement instrument 15 further comprises a screen or display 23. The display 23 is configured to show predefined information, whereas the information can also be remotely requested. In particular, the display 23 may output uncertainty information is shown on the screen:
Error bars in spectrum for amplitude flatness or error bars in level display for level uncertainty;
Thick grey and/or opaque line just behind the spectrum line. The thickness of the line may describe the measurement uncertainty. As an alternative, this could also be illustrated with varying color or transparency with more/less likelihood of the measurement point.
Text-information, e.g. in a suitable table.

Although the present invention has been described in the above by way of preferred embodiments, it is not limited thereto, but rather can be modified in a wide range of ways. In particular, the invention can be changed or modified in various ways without deviating from the core of the invention.

### LIST OF REFERENCE SIGNS

10 customer portal
11 input terminal
12 database
13 controller
14 human-machine interface
15 measuring equipment
16 instrument
16a testing
17 instrument
17a testing
18 instrument
18a testing
19 output module
20 data sheet
21 (smart) interface
22 software module
23 screen, display
24 database
S1-S7 steps
X performance metrics

What we claim is:

1. A method of creating and optimizing customized data sheets for a predefined instrument type, the method comprising:
determining, using a measurement equipment and controlled by a controller, an amount of performance metrics for a plurality of different instrument types, wherein each set of performance metrics for a specific instrument type is based on a plurality of different performance scenarios;
storing the determined performance metrics together with corresponding information of the instrument type and performance scenarios in a database;
providing a human-machine interface coupled to the database, wherein the human-machine interface is configured to credibly assist the user in performing a user request by employing a guided human-machine interaction process;
receiving the user request via an input terminal of the human-machine interface, wherein the user request comprises a first request for a selected instrument or instrument type of the plurality of instrument types and a second request for a selected subset of performance scenarios of the plurality of different performance scenarios for the selected instrument or instrument type;
generating, by the human-machine interface, a customized data sheet automatically based on the user request by extracting from the database the information of the selected instrument type and the selected subset of performance scenarios together with the corresponding performance metrics.

2. The method of claim 1, further comprising:
operating the selected instrument based on the selected subset of performance scenarios in order to obtain information of the performance metrics under customized operation conditions, and
feeding back the obtained information of the performance metrics under customized operation conditions to at least one of the measurement equipment, the controller or the data-base for an update determination of the amount of performance metrics for the plurality of different instrument types.

3. The method of claim 2, wherein the selected instrument is connected to the measurement equipment, the controller and the database, respectively, via a communication link and wherein the obtained information is forwarded via the communication link immediately or after predefined intervals.

4. The method of claim 2, further comprising:
conducting a maintenance or service of the selected instrument,
reading out the obtained information during the maintenance or service, and
forwarding the read-out obtained information to the measurement equipment, the controller and the database, respectively.

5. The method of claim 1, further comprising:
post-processing the performance metrics, and
storing the post-processed performance metrics together with corresponding information of the instrument type and performance scenarios in the database.

6. The method of claim 1, further comprising:
displaying the extracted information used for the generation of the customized data sheet on a display.

7. The method of claim 6, wherein displaying the extracted information is performed before the step of generating a customized data sheet by the human-machine interface is executed.

8. The method of claim 1, wherein the measurement scenario include at least one of:
input power;
measurement bandwidth;
carrier frequency of an input signal;
signal type;
operating temperature;
setting of the compensations for particular standards;
internal settings.

9. The method of claim 1, wherein the generating step further comprises:
providing a template comprising first fields for the selected subset of performance scenarios, second fields for the corresponding performance metrics and third fields for information of the selected instrument type and wherein the customized data sheet is generated by inserting the information in the corresponding fields.

10. The method of claim 1, wherein the step of determining an amount of performance metrics comprises:
providing the performance metrics by the instrument itself.

11. The method of claim 1, further comprising:
logging the user request from the human-machine-interface, and adding additional performance scenarios to the requested performance scenarios.

12. The method of claim 1, further comprising:
predicting the estimated performance of a device on performance scenarios which are not tested by modeling the actual performance of measurement scenarios which are tested.

13. The method of claim 1, wherein the generated data sheet is an electronic data sheet.

14. The method of claim 1, wherein the human-machine-interface comprises a web service and the guided human-machine interaction process is a web-based service.

15. The method of claim 1, further comprising:
using artificial intelligence techniques for inferring performance metrics.

16. The method of claim 1, further comprising:
storing a compact representation of the performance metrics for all measurement scenarios on the instrument.

17. The method of claim 1, wherein the instrument types is at least one of:
measurement instrument;
test equipment;
spectrum analyzer;
network analyzer;
signal generator;
oscilloscope.

18. A customer portal for creating and optimizing customized data sheets for a predefined instrument type, the customer portal comprising:
a database which is configured to store performance metrics of an instrument type together with corresponding information of the instrument type and performance scenarios;
providing a human-machine interface coupled to the database, wherein the human-machine interface comprises an input terminal for receiving user requests and wherein the human-machine interface is configured
to credibly assist a user in performing a user request by means of a guided human-machine interaction process by receiving from a user a first request for a selected instrument or instrument type of the plurality of instrument types and a second request for a selected subset of performance scenarios of the plurality of different performance scenarios for the selected instrument or instrument type, and
to generate automatically a customized data sheet based on the user request by extracting from the database the information of the selected instrument type and the selected subset of performance scenarios together with the corresponding performance metrics.

19. The customer portal of claim 18, further comprising:
a feed-back-loop, wherein the feed-back-loop is configured to be connectable to a selected instrument, wherein during customized operation condition the selected instrument is operated based on the selected subset of performance scenarios, and wherein the feedback-loop is further configured to feedback the obtained information of the performance metrics under customized operation conditions to the database for additionally storing these obtained information in the database.

20. A non-transitory computer-readable recording medium, storing instructions executable by a computer processor, causing the computer processor to execute a method of creating and optimizing customized data sheets for a predefined instrument type, comprising:
determining an amount of performance metrics for a plurality of different instrument types, wherein each set of performance metrics for a specific instrument type is based on a plurality of different performance scenarios;
storing the determined performance metrics together with corresponding information of the instrument type and performance scenarios in a database;
receiving the user request via an input terminal of a human-machine interface, which human-machine interface is configured to credibly assist the user in performing a user request by means of a guided human-machine interaction process, wherein the user request comprises a first request for a selected instrument or instrument type of the plurality of instrument types and a second request for a selected subset of performance scenarios of the plurality of different performance scenarios for the selected instrument or instrument type;
generating a customized data sheet automatically based on the user request by extracting from the database the information of the selected instrument type and the selected subset of performance scenarios together with the corresponding performance metrics.
